(19) United States
(12) Patent Application Publication
(10) Pub. No.: US 2019/0382421 A1
(43) Pub. Date: Dec. 19, 2019

(54) CARBOCATIONICALLY HYDROSILYLATABLE MIXTURE

(71) Applicant: WACKER CHEMIE AG, Munich (DE)

(72) Inventor: Elke Fritz-Langhals, Ottobrunn (DE)

(21) Appl. No.: 16/488,465

(22) PCT Filed: Feb. 24, 2017
(86) PCT No.: PCT/EP2017/054304

§ 371 Date: Aug. 23, 2019

(51) Int. Cl. C07F 7/08

(52) U.S. Cl. CPC C07F 7/0896; B01J 31/146

(57) ABSTRACT

Subject-matter of the invention is a hydrosilylatable mixture M comprising compound (C), which contains at least one carbocationic structure, and compound (A), which has at least one directly Si-bonded hydrogen atom and compound (B), which contains at least one carbon-carbon multiple bond, or compound (AB), where between the Si—H group and the nearest adjacent carbon atom of the carbon-carbon multiple bond there are at least 6 atoms, or compound (A) and compound (AB) or compound (B) and compound (AB), where the compounds (A), (B) and (AB) are defined in claim 1.

The invention relates to a hydrosilylatable mixture M comprising compounds having at least one hydrogen atom directly bonded to Si and at least one carbon carbon multiple bond and also a compound having a carbocationic structure.

The addition of hydrosilicon compounds to alkenes and alkynes with formation of an Si—C linkage plays an important role in industry. This reaction, referred to as hydrosilylation, is used for example, for crosslinking siloxanes or for introducing functional groups into silanes or siloxanes. The hydrosilylation is generally catalyzed by noble metal complexes. Very frequently used are platinum, rhodium or iridium complexes, which make the method considerably more costly, especially if the noble metal cannot be recovered and remains in the product.

Noble metals are only available to a limited extent as raw materials and are subject to unpredictable and uncontrollable price fluctuations. A hydrosilylation process, which is free of noble metal is therefore of major industrial interest. However, a broadly applicable method for noble metal-free hydrosilylation is not known.

Can. J. Chem. 2003, 81, 1223 describes only the intramolecular addition reaction of a cyclopentene comprising a hydridosilane moiety in the presence of tritylium tetra(pentafluorophenyl)borate. In this reaction, as formulated by the authors, a persistent particularly well stabilized norborynyl carbenium ion can form, and as a result the desired reaction is strongly favored. The intermediate silylium ion formed also experiences high intramolecular electronic stabilization by π-electrons. Furthermore, the reaction takes place intramolecularly, which also considerably favors the reaction.

Likewise, an intramolecular hydrosilylation of an alkyne in the presence of 1-4 mol % tritylium tetra(pentafluoropheny)borate is also described in Molecules 2016, 21, 999.

In both reactions, the possibility to extend the reaction to open-chain systems is not to be expected.

J. Org. Chem. 1999, 64, 2729 and J. Am. Chem. Soc. 1996, 118, 7867 describes the addition of triethylsilane to 1,1-diphenylethylene in the presence of 2 mol % tritylium tetra(pentafluorophenyl)borate to form an isolatable diphenylcarbenium ion and subsequent reaction thereof to form the addition product Et₃Si—CH₂—CHPh₂. Also in this case, the high stability of the cationic intermediate, here with two stabilizing phenyl radicals (double benzyl stabilization), is attributed a crucial significance. Analogously, in J. Phys. Org. Chem. 2002, 15, 667, a system is used stabilized by a phenyl radical and an allyl radical, i.e. also a double π-stabilized system, which may appear to restrict such reactions to highly stabilized addition states. In addition, the aim of this work was the preparation of a cationic silicon species and not hydrosilylation.

The object of the present invention consisted of providing a broadly applicable noble metal-free hydrosilylation method.

The invention relates to a hydrosilylatable mixture M comprising
compound (C), which comprises at least one carbocationic structure, and
compound (A) having at least one hydrogen atom directly bonded to Si, and compound (B), which comprises at least one carbon-carbon multiple bond or compound (AB), in which at least 6 atoms are arranged between the Si—H group and the nearest carbon atom of the carbon-carbon multiple bond or compound (A) and compound (AB) or
compound (B) and compound (AB),
   wherein
the compound (A) has the general formula I

R¹R²R³Si—H (I)

where
R¹, R² and R³ each independently have the definition hydrogen, halogen, silyloxy radical, hydrocarbon radical or hydrocarbonoxy radical, wherein individual carbon atoms may in each case be replaced by oxygen atoms, silicon atoms, nitrogen atoms, halogen, sulfur or phosphorus atoms and
the compound (B) is selected from compounds having at least one carbon-carbon double bond of the general formula IIIa

R⁴R⁵C═CR⁶R⁷ (IIIa),

and from compounds having at least one carbon-carbon triple bond of the general formula IIIb

R⁸C≡CR⁹ (IIIb),

where
R⁴, R⁵, R⁶, R⁷, R⁸ and R⁹ are each independently linear, branched, acyclic or cyclic, saturated or monounsaturated or polyunsaturated C1-C20 hydrocarbon radicals, wherein individual carbon atoms may be replaced by silicon, oxygen, halogen, nitrogen, sulfur or phosphorus,
with the proviso that only one of the two radicals R⁴ and R⁵ comprises a double bond conjugated with the central C═C double bond
and with the proviso that only one of the two radicals R⁶ and R⁷ comprises a double bond conjugated with the central C═C double bond.

Surprisingly, it has been found that hydrosilylation reactions result in the desired addition products in high yields in the presence of carbocationic structures, such as triphenylmethylium cations, even without multiple favorable factors, for example by means of two or more π-systems or by spatial proximity of the reacting moieties in intramolecular reactions. The carbocationic structure has a cationic carbon atom.

Recent developments of severely limiting technical preconceptions that such particular multiple stabilizing influences are prerequisites for the success of the hydrosilylation is refuted by the intermolecular hydrosilylation reactions in the presence of tritylium salts according to the invention.

It could be shown, for example, that hydrosilylations of hydriodosilanes and hydridosiloxanes on α-methylstyrene, which bears only one stabilizing phenyl radical, in the presence of tritylium tetra(pentafluorophenyl)borate, proceeds very rapidly and in high yields.

In the known hydrosilylation reactions in the presence of triphenylmethylium cations, aromatic hydrocarbons were also always used for stabilization as solvents, since an aromatic stabilization was considered necessary.

Owing to this surprising effect, the industrial and economic use of the reaction is enabled.

The radicals R¹, R² and R³ are preferably each independently hydrogen, halogen, unbranched, branched, linear, acyclic or cyclic, saturated or monounsaturated or polyunsaturated C1-C20 hydrocarbon radicals or unbranched, branched, linear or cyclic, saturated or monounsaturated or polyunsaturated C1-C20 hydrocarbonoxy radicals, wherein individual carbon atoms may be replaced by oxygen, halogen, nitrogen or sulfur, or silyloxy radicals of the general formula II

(SiO_{4/2})ₐ(R^{x}SiO_{3/2})_{b}(R^{x}₂SiO_{2/2})_{c}(R^{x}₃SiO_{1/2})_{d}— (II)

in which
R^{x} are each independently hydrogen, halogen, unbranched, branched, linear, acyclic or cyclic, saturated or monounsaturated or polyunsaturated C1-C20 hydrocarbon radicals or unbranched, branched, linear or cyclic, saturated or monounsaturated or polyunsaturated C1-C20 hydrocarbonoxy radicals, wherein individual carbon atoms may be replaced by oxygen, halogen, nitrogen or sulfur,
a, b, c and d are each independently integral values from 0 to 100 000, wherein the sum total of a, b, c and d together have at least the value 1.

The radicals R¹, R² and R³ are particularly preferably each independently hydrogen, chlorine, a C1-C3-alkyl or C1-C3 alkylene radical, a phenyl radical, a C1-C4 alkoxy radical or silyloxy radical of the general formula II, in which R^{x} are each independently hydrogen, chlorine, C1-C6 alkyl or alkylene, phenyl or C1-C6 alkoxy.

Particularly preferably, the radicals R¹, R² and R³ are the radicals methyl, methoxy, ethyl, ethoxy, propyl, propoxy, phenyl, chlorine or silyloxy radical, especially of the general formula II.

Particularly preferably, the radicals R^{x} are the radicals methyl, methoxy, ethyl, ethoxy, propyl, propoxy, phenyl and chlorine.

Examples of compounds A of the general formula (I) are the following silanes (Ph=phenyl, Me=methyl, Et=ethyl): Me₃SiH, Et₃SiH, Me₂PhSiH, MePh₂SiH, Me₂ClSiH, Et₂ClSiH, MeCl₂SiH, Cl₃SiH, Me(MeO)SiH, Me(MeO)₂SiH, (MeO)₃SiH, Me₂(EtO)SiH, Me(EtO)₂SiH, (EtO)₃SiH, (Me)₂HSi—O—SiH(Me)₂ and the following siloxanes:
HSiMe₂—O—SiMe₂H, Me₃Si—O—SiHMe—O—SiMe₃,
H—SiMe₂—(O—SiMe₂)ₘ—O—SiMe₂—H where m=1 to 20 000,
Me₃Si—O—(SiMe₂—O)ₙ(SiHMe—O)ₒ—SiMe₃ where n=1 to 20 000 and o=1 to 20 000.

The compound A can also be a mixture of various compounds of the general formula (I), in which optionally the radicals R¹, R² and R³ can be different radicals of the general formula (II).

Mixtures of the compounds of the general formula IIIa and IIIb can also be present.

The radicals R⁴, R⁵, R⁶, R⁷, R⁸ and R⁹ are preferably each independently hydrogen, linear, branched, acyclic or cyclic, saturated or monounsaturated or polyunsaturated C1-C6 hydrocarbon radicals, which can be substituted by one or more heteroatom moieties, which are selected in particular from the moieties halogen, especially chlorine, amino, nitrile, alkoxy, COOR^{z}, O—CO—R^{z}, NH—CO—R^{z}, O—CO—OR^{z}, wherein R^{z} is each independently hydrogen, chlorine, C1-C6 alkyl or alkylene, phenyl or C1-C6 alkoxy.

Preferably one or more radicals R⁴ to R⁹ are hydrogen.

The compound of the general formula IIIa is especially preferably a silane or siloxane of the general formula R¹⁰R¹¹R¹²Si—CH═CH₂, in which the radicals R¹⁰, R¹¹ and R¹² have the definition and preferred definitions for R¹, R² and R³ specified above.

The radicals R¹⁰, R¹¹ and R¹² are particularly preferably the radicals methyl, methoxy, ethyl, ethoxy, propyl, propoxy, phenyl, chlorine or silyloxy radical, especially of the general formula II.

Examples of compounds B are ethylene, propylene, 1-butylene, 2-butylene, cyclohexene,
styrene, α-methylstyrene, 1,1-diphenylethylene, cis-stilbene, trans-stilbene,
allyl chloride, allylamine, acrylonitrile, allyl glycidyl ether, vinyl acetate,
vinyl-Si(CH₃)₂OMe, vinyl-SiCH₃(OMe)₂, vinyl-Si(OMe)₃
vinyl-Si(CH₃)2—[O—Si(CH3)2]n-vinyl where n=0 to 10 000
acetylene, propyne, 1-butyne, 2-butyne and phenylacetylene.

The compound (AB) can be composed of compound A of the general formula I and compound B of the general formula IIIa or IIIb, wherein at least one of the radicals R¹, R² and R³ is attached to at least one of the radicals R⁴, R⁵, R⁶, R⁷, R⁸ and R⁹. Preferably, at least 7, in particular at least 8 atoms are arranged between the Si—H group and the nearest carbon atom of the carbon-carbon multiple bond.

The compound (C) comprises one or more carbocationic structures corresponding preferably to the general formula IV

(R¹³R¹⁴R¹⁵)C⁺X⁻ (IV)

wherein the radicals R¹³, R¹⁴ and R¹⁵ are preferably aromatic radicals of the formula V,

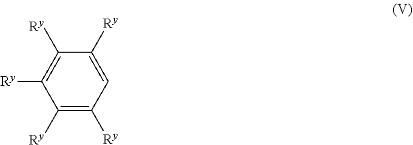

in which
R^{y} are any radicals, which may also bond to one another to form fused rings.
The radicals R^{y} are each independently preferably hydrogen, linear or branched, acyclic or cyclic, saturated or monounsaturated or polyunsaturated C1-C20 alkyl or aryl radicals, in which hydrocarbon moieties may be replaced by oxygen or sulfur, or halogen.
The radicals R^{y} are particularly preferably hydrogen, linear or branched, acyclic or cyclic, saturated or monounsaturated or polyunsaturated C1-C7 alkyl or aryl radicals, C1-C6 alkoxy radicals, fluorine or chlorine.
X⁻ is preferably an anion, which does not react with the cationic carbon center under the reaction conditions. Preferred anions are therefore anions in which the negative charge is sterically hindered and/or diminished by electronic effects, for example inductive or mesomeric effects. Particular preference is given to WCAs (=weakly coordinating anions), since these only form weak interactions with the cationic carbon center and their reactivity is not attenuated. WCAs are known to the skilled person. An overview can be found, for example, in Krossing et. al., Angew. Chem. 2004, 116, 2116.

Examples of WCAs are ClO₄⁻, borates, e.g. B(C₆H₅)₄⁻, BF₄⁻, BCl₄⁻, B(C₆F₅)₄⁻, BCl(C₆F₅)₃⁻, B(CF₃)₄⁻, B(C₆H₃(CF₃)₂), B(OR^{F})₄⁻, boranates, for example B₁₂F₁₂⁻, C₃H₅B₁₁F₁₁⁻, CH₆B₁₁Cl₆, CH₆B₁₁Br₆, B₁₂Cl₁₂⁻, CH₁₁B₁₁Br, aluminates, for example EtAlCl₃—, AlCl₄⁻, AlBr₄⁻, Al(C₆F₅)₄⁻, alkoxyaluminates, for example Al(OR^{F})₄⁻, AlF(OR^{F})₃⁻ and AlCl(OR^{F})₃⁻, wherein the radicals R^{F} are fluorinated alkyl or aryl radicals, for example C₆F₅, —CH(CF₃)₂ or —C(CF₃)₃, PF₆⁻, PCl₆⁻, AsF⁶⁻, AsCl₄⁻, SbF₆⁻, SbCl₄⁻, SbCl₆⁻, SnCl₅⁻, SnBr₄⁻, TiCl₅⁻, FeCl₄⁻, GaCl₄⁻, InCl₄⁻, ZrCl₆⁻, CF₃SO₃⁻, FSO₃⁻ and CF₃COO⁻.

The molar ratio of the compounds (A) and (B), based on the Si—H groups and the unsaturated carbon moieties present, is preferably at least 1:100 and at most 100:1, particularly preferably at least 1:10 and at most 10:1, especially preferably at least 1:2 and at most 2:1.

The molar ratio between the compound (C) and the Si—H groups present is preferably at least 1:10⁸ and at most 1:1, particularly preferably at least 1:10⁷ and at most 1:100, especially preferably at least 1:10⁶ and at most 1:500. The compounds (A), (B) and (C) can be mixed in any sequence, wherein the mixing is effected in a manner known to the skilled person. It is also possible to mix the compounds (A) and (B) or (A) and (C) or (B) and (C) and then to add the missing component.

The reaction of the compounds (A) and (B) in the presence of component (C) can be carried out with or without addition of one or more solvents. The proportion of solvent or solvent mixture, based on the sum total of compounds (A) and (B), is preferably at least 0.1% by weight and at most the 1000-fold amount by weight, particularly preferably at least 10% by weight and at most the 100-fold amount by weight, especially preferably at least 30% by weight and at most the 10-fold amount by weight.

The solvents used can be, for example, aliphatic hydrocarbons such as pentane, hexane, heptane, cyclohexane, aromatic hydrocarbons such as benzene, toluene or xylene, chlorohydrocarbons such as dichloromethane, chloroform, chlorobenzene or 1,2-dichloroethane, ethers such as diethyl ether, methyl tert-butyl ether, anisole, tetrahydrofuran or dioxane, or nitrile such as acetonitrile or propionitrile for example.

The solvents preferably do not comprise any aromatic or heteroaromatic groups.

The reaction mixture may comprise any further desired components such as processing aids, e.g. emulsifiers, fillers, e.g. highly dispersed silica or quartz, stabilizers, e.g. radical inhibitors, pigments, e.g. dyes or white pigments, e.g. chalk or titanium dioxide.

The reaction can be carried out at atmospheric pressure or under reduced or elevated pressure.

The pressure is preferably at least 0.01 bar and at most 100 bar, particularly preferably at least 0.1 bar and at most 10 bar, especially preferably the reaction is carried out at atmospheric pressure. However, if compounds are involved in the reaction which are gaseous at the reaction temperature, the reaction is preferably carried out under elevated pressure, particularly preferably at the vapor pressure of the whole system.

The reaction of compounds (A) and (B) in the presence of (C) is preferably conducted at temperatures between at least −100° C. and at most +250° C., particularly preferably between at least −20° C. and at most 150° C., especially preferably between at least 0° C. and at most 100° C.

All aforementioned symbols relating to the formulae above have definitions in each case that are independent of one another. In all formulae, the silicon atom is tetravalent. The sum of all constituents of the silicon mixture add up to 100% by weight.

In the following examples, unless stated otherwise, all amounts and percentages are based on weight, all pressures are 0.10 MPa (abs.) and all temperatures are 20° C.

### EXAMPLE 1

136 mg (1.00 mmol) of dimethylphenylsilane in 0.5 ml of d₂-dichloromethane are mixed with a solution of 118 mg (1.00 mmol) of α-metylstyrene in 0.5. ml of d₂-dichloromethane and a solution of 0.9 mg (1.0 μmol, 0.1 mol %) of trityl tetrakis(pentafluorophenyl)borate in 0.5 ml of d₂-dichloromethane is added. After a reaction time of 10 min, the reaction is stopped by adding one drop of pyridine. ¹H-NMR spectroscopic investigation shows >97% conversion with formation of the hydrosilylation product Ph—CH(CH₃)—CH₂—SiPh(CH₃)₂.

### EXAMPLE 2

148 mg (1.00 mmol) of pentamethyldisiloxane in 0.5 ml of d₂-dichloromethane are mixed with a solution of 118 mg (1.00 mmol) of α-methylstyrene in 0.5 ml of d₂-dichloromethane and a solution of 1.0 mg (1.0 μmol, 0.11 mol %) of trityl tetraakis(pentafluorophenyl)borate in 0.5 ml of d₂-dichloromethane is added. After a reaction time of 10 min, the reaction is stopped by adding one drop of pyridine. ¹H-NMR spectroscopic investigation shows quantitative conversion with formation of the hydrosilylation product Ph—CH(CH₃)—CH₂—Si(CH₃)₂—O—Si(CH₃)₃.

### EXAMPLE 3

118 mg (1.00 mmol) of triethylsilane in 0.5 ml of d₂-dichloromethane are mixed with a solution of 119 mg (1.01 mmol) of α-methyl styrene in 0.5 ml of d₂-dichloromethane and a solution of 1.0 mg (1.0 μmol, 0.11 mol %) of trityl tetraakis(pentafluorophenyl)borate in 0.5 ml of d₂-dichloromethane is added. The reaction is monitored by ¹H-NMR spectroscopy. After 19 min. the conversion is 79%, after 73 min. 88% and after 130 min. the conversion is quantitative with formation of the hydrosilylation product Ph—CH(CH₃)—CH₂—Si(CH₂—Si(CH₃)₃.

### EXAMPLE 4

136 mg (1.00 mmol) of dimethylphenylsilane in 0.5 ml of d₂-dichloromethane are mixed with a solution of 85 mg (1.00 mmol) of 1-hexene in 0.5 ml of d₂-dichloromethane and a solution of 0.9 mg (1.0 μmol, 0.10 mol %) of trityl tetraakis(pentafluorophenyl)borate in 0.5 ml of d₂-dichloromethane is added and mixed by stirring. After 5 hours at room temperature, the solution is mixed with 1 drop of pyridine and the amount of product is determined by gas chromatography. Approx. 65% of the hydrosilylation product dimethylhexylphenylsilane was formed.

1. A hydrosilylatable mixture M comprising:
a compound (C), comprising at least one carbocationic structure, and a compound (A) having at least one hydrogen atom directly bonded to Si, and a compound (B), comprising at least one carbon-carbon multiple bond or a compound (AB), in which at least 6 atoms are arranged between the Si—H group and the nearest carbon atom of the carbon-carbon multiple bond or the compound (A) and the compound (AB) or the compound (B) and the compound (AB), wherein the compound (A) has the general formula I
R¹R²R³S—H (I)
where
R¹, R² and R³ are each independently hydrogen, chlorine, C1-C3-alkyl or C1 -C3-alkylene radicals, phenyl radicals, C1-C4 alkoxy radicals or silyloxy radicals of the general formula II,
(SiO_{4/2})ₐ(R^{x}SiO_{3/2})_{b}(R^{x}₂SiO_{2/2})_{c}(R^{x}₃SiO_{1/2})_{d}— (II)
in which R^{x} are each independently hydrogen, chlorine, C1-C6 alkyl or alkylene, phenyl or C1-C6 alkoxy and a, b, c and d are each independently integral values from 0 to 100 000, wherein the sum total of a, b, c and d together have at least the value 1 and the compound (B) is selected from compounds having at least one carbon-carbon double bond of the general formula IIIa
R⁴R⁵C═CR⁶R⁷ (IIIa),
wherein
R⁴, R⁵, R⁶ and R⁷ are each independently linear, branched, acyclic or cyclic, saturated or monounsaturated or polyunsaturated C1-C20 hydrocarbon radicals, wherein individual carbon atoms may be replaced by silicon, oxygen, halogen, nitrogen, sulfur or phosphorus, with the proviso that only one of the two radicals R⁴ and R⁵ comprises a double bond conjugated with the central C═C double bond and with the proviso that only one of the two radicals R⁶ and R⁷ comprises a double bond conjugated with the central C═C double bond, wherein the molar ratio between the compound (C) and the Si—H groups present is from 1:10⁸ to 1:100.

2. A method for hydrosilylation, comprising:
reacting a hydrosilylatable mixture M, mixture M comprising compound (C), which comprises at least one carbocationic structure and a compound (A) having at least one hydrogen atom directly bonded to Si, and a compound (B), which comprises at least one carbon-carbon multiple bond or a compound (AB), in which at least 6 atoms are arranged between the Si—H group and the nearest carbon atom of the carbon-carbon multiple bond or the compound (A) and the compound (AB) or the compound (B) and the compound (AB), wherein the compound (A) has the general formula I
R¹R²R³S—H (I)
where
R¹, R² and R³ each independently have the definition hydrogen, halogen, silyloxy radical, hydrocarbon radical or hydrocarbonoxy radical, wherein individual carbon atoms may in each case be replaced by oxygen atoms, silicon atoms, nitrogen atoms, halogen, sulfur or phosphorus atoms and the compound (B) is selected from compounds having at least one carbon-carbon double bond of the general formula IIIa
R⁴R⁵C═CR⁶R⁷ (IIIa),
and from compounds having at least one carbon-carbon triple bond of the general formula IIIb
R⁸C≡CR⁹ (IIIb),
where where
R⁴, R⁵, R⁶, R⁷, R⁸ and R⁹ are each independently linear, branched, acyclic or cyclic, saturated or monounsaturated or polyunsaturated C1-C20 hydrocarbon radicals, wherein individual carbon atoms may be replaced by silicon, oxygen, halogen, nitrogen, sulfur or phosphorus, with the proviso that only one of the two radicals R⁴ and R⁵ comprises a double bond conjugated with the central C═C double bond and with the proviso that only one of the two radicals R⁶ and R⁷ comprises a double bond conjugated with the central C═C double bond wherein the molar ratio between the compound (C) and the Si—H groups present is from 1:10⁸ to 1:100.

3. The hydrosilylatable mixture M of claim 1, wherein the compound (C) comprises one or more carbocationic structures corresponding to the general formula IV
(R¹³R¹⁴R¹⁵)C⁺X⁻ (IV)
wherein the radicals R¹³, R¹⁴ and R¹⁵ are aromatic radicals of the formula V, 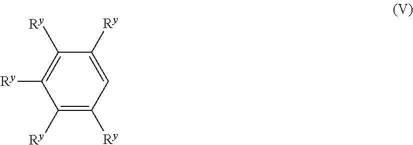
in which
R^{y} are any radicals, which may also bond to one another to form fused rings and
X⁻ is an anion, which does not react with the cationic carbon center under the reaction conditions.

4. The hydrosilylatable mixture M of claim 3, wherein the radicals R^{y} are each independently hydrogen, linear or branched, acyclic or cyclic, saturated or mono- or polyunsaturated C1-C20 alkyl or aryl radicals, in which carbon moieties can be replaced by oxygen or sulfur, or halogen.

5. The method of claim 2, wherein the radicals R⁴, R⁵, R⁶, R⁷, R⁸ and R⁹ are each independently hydrogen, linear, branched, acyclic or cyclic, saturated or monounsaturated or polyunsaturated C1-C6 hydrocarbon radicals, which can be substituted by one or more heteroatom moieties.

6. The method for hydrosilylation of claim 2, wherein the compound (C) comprises one or more carbocationic structures corresponding to the general formula IV:
(R¹³R¹⁴R¹⁵)C⁺X⁻ (IV)
wherein the radicals R¹³, R¹⁴ and R¹⁵ are aromatic radicals of the formula V, 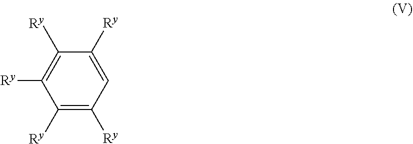
in which
R^{y} are any radicals, which may also bond to one another to form fused rings and
X⁻ is an anion which does not react with the cationic carbon center under the reaction conditions.

7. The method for hydrosilylation of claim 6, wherein the radicals R^{y} are each independently hydrogen, linear or branched acyclic or cyclic, saturated or mono- or polyunsaturated C1-C20 alkyl or aryl radicals, in which carbon moieties can be replaced by oxygen or sulfur, or halogen.
